(19) United States
(12) Patent Application Publication
(10) Pub. No.: US 2025/0007680 A1
(43) Pub. Date: Jan. 2, 2025

(54) POWER TOOL HAVING A COMMUNICATION CONNECTION FOR SERIAL DIGITAL COMMUNICATION BETWEEN TWO TRANSCEIVERS, AND SYSTEM

(71) Applicant: Hilti Aktiengesellschaft, Schaan (LI)

(72) Inventors: Klaus HAUSER, Schwabmünchen (DE); Mathias FRENZEL, Unterdießen (DE); Markus HARTMANN, Mauerstetten (DE); Robert STANGER, Kaufbeuren (DE)

(21) Appl. No.: 18/709,560

(22) PCT Filed: Nov. 10, 2022
(86) PCT No.: PCT/EP2022/081457

§ 371 Date: May 13, 2024

(30) Foreign Application Priority Data
Dec. 1, 2021 (EP) 21211578.6
Dec. 1, 2021 (EP) 21211579.4

(51) Int. Cl. H04L 5/16; B25F 5/00; H01M 10/42; H01M 50/247; H04B 1/40

(52) U.S. Cl. CPC H04L 5/16; B25F 5/00; H01M 10/425; H01M 50/247; H04B 1/40; H01M 2220/30

(57) ABSTRACT

A power tool having at least one control device, wherein the power tool can be detachably connected to an energy supply device, wherein there is provision for at least one communication connection for the exchange of signals between a first transceiver and a second transceiver by using serial digital communication, wherein the energy supply device comprises at least one energy storage cell and the at least one cell has a nominal capacity of at least 1.5 ampere hours, and also a surface A and a volume V, the surface A of the at least one cell being greater than eight times the cube root of the square of the volume V of the at least one cell. A system that includes such a power tool and an energy supply device is also provided.

The present invention relates to a power tool having at least one control device, wherein the power tool can be detachably connected to an energy supply device. In a second aspect, the invention relates to a system that comprises such a power tool and an energy supply device.

### BACKGROUND OF THE INVENTION

Modern power tools, such as for example hammer drills, saws, grinders or the like, nowadays have numerous components (for example a motor unit, transmission unit, transceiver, microcontroller, etc.) that exchange a great amount of information and data in the form of signals. A high level of information and data exchange now takes place in particular between a power tool and a rechargeable battery provided as a power supply.

### SUMMARY OF THE INVENTION

Various communication networks or communication circuits are used for exchanging data (i.e. sending and receiving information). The communication between the individual components, i.e. the data exchange, usually takes place without any problem when the power tool is in an inoperative state. In the inoperative state, the power tool is not activated and the drive is only supplied with relatively little electrical energy (i.e. low current values or current intensity).

By contrast, in an operative mode of the power tool, a relatively great amount of electrical energy (i.e. high current values or current intensity) is supplied in order to produce a high power output of the power tool.

However, high current values, and especially relatively rapidly changing current values (i.e. great fluctuation), produce unwanted interference coupling (for example inductive coupling, capacitive coupling, electromagnetic radiation and/or line-bound interference) on a neighboring signal line in the communication network. Since the technical measures for suitable interference immunity on the communication networks usually cause a considerable amount of effort and increased costs, a consequence of this is to dispense with communication between the components during operation (i.e. in the active mode) of the power tool.

By way of example, EP 3 795 302 A1 discloses robust communication in a power tool, in which signals are exchanged in a half-duplex mode.

US 2014 0131 059 A1 discloses a battery-powered power tool that includes a brushless DC motor. The power tool or the battery can be designed to communicate serially.

It is an object of the present invention to provide a power tool and a system comprising a power tool and an energy supply device that can be used to solve the above-mentioned problem and to achieve robust communication during operation of the power tool or the system.

The present invention provides a power tool having at least one control device, wherein the power tool can be detachably connected to an energy supply device, wherein there is provision for at least one communication connection for the exchange of signals between a first transceiver and a second transceiver by using serial digital communication, wherein the energy supply device comprises at least one energy storage cell and the at least one cell has a nominal capacity of at least 1.5 ampere hours, and also a surface A and a volume V, the surface A of the at least one cell being greater than eight times the cube root of the square of the volume V of the at least one cell. This allows robust and interference-resistant communication even while the power tool is in operation. The serial communication is preferably characterized in that individual data bits can be sent or transmitted one after the other. Tests have shown that the invention allows in particular safety-relevant functions of the power tool to be implemented better than with conventional power tools, as are known from the prior art.

There is provision according to the invention for the power tool to be able to be detachably connected to an energy supply device, the energy supply device preferably being configured to supply the power tool with electrical energy. The energy supply device can preferably comprise a rechargeable battery or be formed by a rechargeable battery, which means that the terms “energy supply device” and “rechargeable battery” are used synonymously in the context of the present invention. It is quite particularly preferred in the context of the invention for the first transceiver to be positioned in the power tool and the second transceiver to be positioned in the energy supply device. In other words, the first transceiver, or the first communication partner, in the serial digital communication can be part of the power tool, while the second transceiver, or the second communication partner, in the serial digital communication is preferably integrated in the energy supply device. The invention therefore allows signals and/or data to be exchanged between a power tool and an energy supply device in a particularly interference-resistant manner. The wording that the first transceiver is positioned in the power tool and the second transceiver is positioned in the energy supply device is not inconsistent with the communication circuit of the power tool being intended for the exchange of signals between a first transceiver and a second transceiver. This is because if the energy supply device is connected to the power tool in order to supply the power tool with electrical energy, the energy supply device can be regarded as part or a component of the power tool. In this case, the second transceiver can be part of the energy supply device and the power tool at the same time. The following configuration options for the transceivers are preferred in the context of the invention:

a) The first transceiver is positioned in the power tool and the second transceiver is positioned in the energy supply device.

b) The first and second transceivers are positioned in the power tool.

In the first case, the invention can be described using alternative wording as follows: A power tool having at least one control device is provided, wherein there is provision for at least one communication circuit for the exchange of signals between a first transceiver and a second transceiver having at least one communication line for serial digital communication, wherein the first transceiver is positioned in the power tool and the second transceiver is positioned in the power tool or in the energy supply device.

It may also be preferred in the context of the invention for both transceivers to be arranged in the power tool.

It is preferred in the context of the invention for the communication connection to comprise a communication circuit having at least one communication line for wired transmission of signals by way of the serial digital communication and/or means for wireless transmission of signals by way of the serial digital communication. This preferably means in the context of the invention that the communication between the transceivers can be wired or wireless.

It is preferred in the context of the invention for signals to be exchanged in a half-duplex mode or in a full-duplex mode. In addition, signals can be exchanged with reference to ground or as part of differential communication. It is preferred in the context of the invention for the communication circuit to have ground lines, which are preferably low-impedance connections that can be used to compensate for potential differences between the transceivers. The term “with reference to ground” should be understood in the context of the invention to mean that a communication signal is referenced to ground if the voltage is measured with respect to a ground potential, preferably a common ground potential. In the context of the present invention, the negative pole of the energy supply device of the power tool is preferably used as a common ground potential.

The communication connection, or the communication circuit, of the power tool can preferably comprise two communication lines if the communication between the transceivers is referenced to ground and based on full-duplex technology. The communication circuit of the power tool can preferably comprise four communication lines if the communication between the transceivers takes place as part of differential communication and is based on full-duplex technology. Preferably, the communication circuit of the power tool can comprise a communication line if the communication between the transceivers is referenced to ground and based on half-duplex technology. The communication circuit of the power tool can preferably comprise two communication lines if the communication between the transceivers takes place as part of differential communication and is based on half-duplex technology.

The signals that are exchanged between the transceivers can preferably be physical signals, such as voltage signals referenced to ground, differential voltage signals and/or current signals.

In the case of signals referenced to ground, signal levels of −3 V to −15 V in a first state A and 3 V to 15 V in a second state B are preferred, depending on the communication method. In another method, signal levels between 2 and 10 V in a first state A and between −0.4 V and 0.8 V in a second state B may be preferred. In the context of the invention, the states A and B and the states HZ and NZ denote the two binary states in which a digital signal can be present. It is preferred in the context of the invention for the serial communication to involve these bits or states being sent in strung-together or concatenated form in a specific interval of time.

It is preferred in the context of the invention for a first differential voltage in the differential communication for a first state (HZ) to be between −20 V and 1 volt and a second differential voltage for a second state to be between 1.5 and 20 volts.

In the case of differential communication, the first state may also be referred to as the dominant or high state. Furthermore, in the case of differential communication, the second state may also be referred to as the recessive or low state.

According to an advantageous embodiment of the present invention, it may be possible for there to be provision for at least one rechargeable battery as the power supply for the power tool, the energy supply device having a ground potential. The ground potential of the energy supply device can preferably also be referred to as ground, zero potential or earth.

It is preferred in the context of the invention for a data transmission rate to be in a range from 9.6 kbit/s to 5 Mbit/s. Tests have shown that a data transmission rate in a range from 9.6 kbit/s to 5 Mbit/s allows efficient and robust communication between a power tool and an energy supply device, even when the power tool is in operation and can be subject to strong vibrations and shocks. Such strong vibrations and shocks can occur in particular with especially high-performance power tools.

It is preferred in the context of the invention for a resistance of the at least one communication line to be less than 1 ohm. This is especially true when the serial digital communication is wired. It has been shown that it is advantageous in wired communication to keep the resistance of the communication line, including any plug connections, below 1 ohm.

The serial digital communication can be based on near-field communication, for example. This is especially true when the serial digital communication is wireless. If the serial digital communication is wireless, it may be preferred for an antenna area of the first transceiver and/or of the second transceiver to be in a range from 4 cm² to 20 cm². This allows particularly robust communication between the communication partners involved. If the serial digital communication is wireless, it may also be preferred for an interval between antennas of the first transceiver and antennas of the second transceiver to be less than 4 cm. In other words, the antennas of the first transceiver are arranged at an interval of less than 4 cm from the antennas of the second transceiver. If the first transceiver is arranged on the power tool and the second transceiver is part of the energy supply device, the antennas of the two transceivers are arranged less than 4 cm apart.

It is preferred in the context of the invention for the communication lines between the transceivers to be twisted together if more than one communication line is used for the serial digital communication between the transceivers of the communication system and if the communication is wired. The twisting allows mutual signal couplings between the communication lines to be compensated for or avoided.

It is preferred in the context of the invention for intervals between line crossing points between the communication lines to be in a range from 5 mm to 25 mm if more than one communication line is used for the serial digital communication. The mentioned intervals between the line crossing points can advantageously contribute to the communication between the transceivers being even more robust with respect to signal interference. In particular, the mentioned intervals between the line crossing points allow particularly robust communication between a particularly high-performance power tool and an energy supply device, which is preferably able to deliver output currents in a range in excess of 50 amperes (A), preferably in excess of 70 A and most preferably in excess of 100 A. It is preferred in the context of the invention for the line crossing points to be created by twisting the communication lines in pairs, the line crossing points preferably being able to occur at intervals of from 5 to 25 mm. It may be preferred in the context of the invention for the line crossing points to occur at regular intervals, so that the line crossing points are substantially equidistant from one another. However, it may also be preferred in the context of the invention for the line crossing points to be at irregular intervals, these intervals preferably being in a range from 5 to 25 mm. It is preferred in the context of the invention for the lines of the differential communication to be referred to as “line pairs”. In addition, when signals are exchanged in a half-duplex mode, matching transmission and reception lines can be referred to as “line pairs”.

It is preferred in the context of the invention for an area that can be enclosed by the communication lines to be less than 20 cm² if more than one communication line is used for the serial digital communication. Such small areas enclosed by the communication lines allow inductive coupling of interference to be reduced to a minimum, so that the communication between the system partners involved—for example power tool and energy supply device—can be particularly robust and not very susceptible to interference. In the context of the invention, the wording that an area can be enclosed by the communication lines preferably means that the applicable area is enclosed by the communication lines. It is preferred in the context of the invention for the term “area” to mean that area which is enclosed by a line pair.

The first and the second communication line for differential communication between the energy supply device and the power tool are parts of a communication system. In this case, the communication system can be configured as a CAN data bus. However, it is also possible to use some other suitable communication system for differential communication between the rechargeable battery and the power tool.

In addition to the power tool, a system is disclosed that comprises a power tool having at least one control device and an energy supply device having at least one control electronics unit, the energy supply device being designed to supply the power tool with electrical energy. It is preferred in the context of the invention for the system contributors-power tool and energy supply device—to be able to communicate with one another and exchange data in the manner described above. There can be provision for a communication connection for the exchange of signals between a first transceiver and a second transceiver, wherein the communication connection can comprise, for example, a communication circuit having at least one communication line for carrying out serial digital communication. Alternatively or additionally, the communication connection can be wireless and can comprise means for wireless transmission of signals by way of the serial digital communication. It is preferred in the context of the invention for the at least first transceiver to be positioned in the power tool and the at least second transceiver to be positioned in the energy supply device. The transceiver-based communication is therefore particularly suitable for communication between particularly high-performance power tools and energy supply devices, as will be described below.

In other words, in a preferred embodiment, the invention relates to a system having a power tool and an energy supply device, the power tool comprising the first transceiver and the energy supply device comprising the second transceiver. The transceivers form a communication circuit for the exchange of signals so as to allow communication between the power tool and the energy supply device by using serial digital communication.

The invention can fully develop its advantages especially when it is used in conjunction with new and future battery or cell technologies. This is because new battery technologies are expected to produce energy supply devices having longer lives and higher output currents. For example, the energy devices can be configured to be able to deliver currents in a range in excess of 50 amperes (A), preferably in excess of 70 A and most preferably in excess of 100 A. The currents are preferably constant currents. A technical solution for the communication of such an energy supply device with a power tool can advantageously be provided using the invention. In the context of the invention, an energy supply device is disclosed which can form a system together with a power tool according to the invention. In other words, the energy supply device can be used in the system. The energy supply device can preferably have the following features:

The energy supply device is preferably an energy supply device with a particularly long service life and/or an energy supply device that is configured to deliver particularly high currents, in particular constant currents in excess of 50 amperes, preferably in excess of 70 amperes and most preferably in excess of 100 amperes.

There is provision according to the invention for the energy supply device to comprise at least one energy storage cell (“cell”), the at least one cell having an internal resistance DCR_I of less than 10 milliohms (mOhm). The internal resistance DCR_I of the at least one energy storage cell is less than 8 milliohms, preferably less than 6 milliohms. Here, the internal resistance DCR_I is preferably measured in accordance with standard IEC61960. The internal resistance DCR_I is in particular the resistance of a cell of the energy supply device, any components or accessories of the cell not contributing to the internal resistance DCR_I. A low internal resistance DCR_I is advantageous, as this means that unwanted heat that needs to be dissipated does not arise at all. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that the internal resistance DCR_I of the at least one cell of less than 10 milliohms allows an energy supply device which has particularly good thermal properties, in the sense that it can be operated particularly well at low temperatures, to be provided, the cooling effort being able to be kept surprisingly low. In particular, an energy supply device with an internal cell resistance DCR_I of less than 10 milliohms is particularly well suited to supplying particularly high-performance power tools with electrical energy. Such energy supply devices can therefore make a valuable contribution to allowing rechargeable-battery-operated power tools to be used even in areas of application that those skilled in the art previously assumed were not open to rechargeable-battery-operated power tools.

Advantageously, such an energy supply device can be used to allow a battery-operated or rechargeable-battery-operated power tool having an energy supply device according to the invention to be supplied with a high output power over a long period of time without damaging the surrounding plastic components or the cell chemistry within the cells of the energy supply device.

It is preferred in the context of the invention for a ratio of a resistance of the at least one cell to a surface A of the at least one cell to be less than 0.2 millionm/cm², preferably less than 0.1 milliohm/cm² and most preferably less than 0.05 millionm/cm². In the case of a cylindrical cell, the surface of the cell can be formed, for example, by the outer surface of the cylinder as well as the top side and the bottom side of the cell. Furthermore, it may be preferred in the context of the invention for a ratio of a resistance of the at least one cell to a volume V of the at least one cell to be less than 0.4 milliohm/cm³, preferably less than 0.3 millionm/cm³ and most preferably less than 0.2 milliohm/cm³. For conventional geometric shapes, such as cuboids, cubes, spheres or the like, a person skilled in the art knows the formulae for calculating the surface or the volume of such a geometric body. In the context of the invention, the term “resistance” preferably denotes the internal resistance DCR_I which can preferably be measured in accordance with standard IEC61960. This is preferably a DC resistance.

It is preferred in the context of the invention for the at least one cell to have a heating coefficient of less than 1.0 W/(Ah·A), preferably less than 0.75 W/(Ah·A) and particularly preferably less than 0.5 W/(Ah·A). Furthermore, the at least one cell can be designed to output a current of greater than 1000 amperes/liter substantially constantly. The discharge current is indicated in respect of the volume of the at least one cell, the volumetric measurement unit “liter” (I) being used as the unit for the volume. The cells according to the invention are therefore able to output a discharge current of substantially constantly greater than 1000 A per liter of cell volume. In other words, a cell with a volume of 1 liter is able to output a substantially constant discharge current of greater than 1000 A, wherein the at least one cell furthermore has a heating coefficient of less than 1.0 W/(Ah·A). In preferred refinements of the invention, the at least one cell of the energy supply device can have a heating coefficient of less than 0.75 W/(Ah·A), preferably less than 0.5 W/(Ah·A). The unit for the heating coefficient is watts/(ampere hours·amperes). The heating coefficient can of course also have intermediate values, such as 0.56 W/(Ah·A); 0.723 W/(Ah·A) or 0.925 W/(Ah·A).

The invention advantageously allows the provision of an energy supply device having at least one cell that exhibits reduced heating and is therefore particularly well suited to supplying power to power tools for which high powers and high currents, preferably constant currents, are desired for operation. In particular, the invention can be used to provide an energy supply device for a power tool in which the heat which is optionally created during operation of the power tool and when outputting electrical energy to the power tool can be dissipated in a particularly simple and uncomplicated manner. Tests have shown that the invention can be used not only to more effectively dissipate existing heat. Rather, the invention prevents heat being generated or the quantity of heat generated during operation of the power tool can be considerably reduced using the invention. The invention can advantageously be used to provide an energy supply device which can supply electrical energy in an optimum manner primarily also to power tools which have stringent requirements in respect of power and discharge current. In other words, the invention can provide an energy supply device for particularly high-performance power tools with which heavy drilling or demolition work can be performed on construction sites for example.

In the context of the invention, the term “power tool” should be understood to mean a typical tool that can be used on a construction site, for example a building construction site and/or a civil engineering construction site. These can be rotary hammers, chisels, core drills, angle or cut-off grinders, cutting tools or the like, without being limited thereto. In addition, auxiliary devices such as those occasionally used on construction sites, such as lamps, radios, vacuum cleaners, measuring devices, construction robots, wheelbarrows, transport devices, feed devices or other auxiliary devices, can be a “power tool” in the context of the invention. The power tool can in particular be a mobile power tool, the energy supply device in particular also being able to be used in stationary power tools, such as rig-mounted drills or circular saws. However, preference is given to hand-held power tools that are, in particular, rechargeable-battery-operated or battery-operated. The power tool can also be a charger for the energy supply device, for example.

It is preferred in the context of the invention for the at least one cell to have a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is present in a manner connected to a power tool. Energy supply devices with temperature cooling half-lives of less than 8 mins have primarily been found to be particularly suitable for use in high-performance power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal loading on the components of the energy supply device or the power tool having the energy supply device can be considerably reduced. As a result, the energy supply device can be preserved and its service life extended.

It is preferred in the context of the invention for the at least one cell to be arranged in a battery pack of the energy supply device. A series of individual cells can preferably be combined in the battery pack and in this way inserted into the energy supply device in an optimum manner. For example, 5, 6 or 10 cells can form a battery pack, with integer multiples of these numbers also being possible. For example, the energy supply device can have individual cell strings, which can comprise, for example, 5, 6 or 10 cells. An energy supply device with, for example, three strands of five cells each can comprise, for example, 15 individual cells.

It is preferred in the context of the invention for the energy supply device to have a capacity of at least 2.2 Ah, preferably at least 2.5 Ah. Tests have shown that the capacity values mentioned are particularly well suited to the use of high-performance power tools in the construction industry and meet the requirements there for the availability of electrical energy and the possible period of use of the power tool particularly well.

The at least one cell of the energy supply device is preferably configured to deliver a discharge current of at least 20 A for at least 10 s. For example, a cell of the energy supply device can be designed to provide a discharge current of at least 20 A, in particular at least 25 A, for at least 10 s. In other words, the at least one cell of an energy supply device can be configured to provide a continuous current of at least 20 A, in particular at least 25 A.

It is also conceivable for peak currents, especially short-term peak currents, to be able to lead to intense heating of the energy supply device. Therefore an energy supply device with high-performance cooling, as can be achieved by the measures described here, is particularly advantageous. It is conceivable, for example, for the at least one cell of the energy supply device to be able to provide at least 50A for 1 second. In other words, it is preferred in the context of the invention for the at least one cell of the energy supply device to be configured to provide a discharge current of at least 50 A for at least 1 s. Power tools can often require high powers for a short period of time. An energy supply device whose cells are capable of delivering a peak current such as this and/or a continuous current such as this can therefore be particularly suitable for high-performance power tools such as those used on construction sites.

It is preferred in the context of the invention for the at least one cell to comprise an electrolyte, the electrolyte preferably being present in a liquid physical state at room temperature. The electrolyte can comprise lithium, sodium and/or magnesium, without being restricted thereto. In particular, the electrolyte can be lithium-based. Alternatively or additionally, said electrolyte can also be sodium-based. It is also conceivable for the rechargeable battery to be magnesium-based. The electrolyte-based energy supply device can have a rated voltage of at least 10 V, preferably at least 18 V, in particular of at least 28 V, for example 36 V. A rated voltage in a range from 18 to 22 V, in particular in a range from 21 to 22 V, is very particularly preferred. The at least one cell of the energy supply device can have, for example, a voltage of 3.6 V, without being restricted thereto.

It is preferred in the context of the invention for the energy supply device to be charged, for example, at a charging rate of 1.5 C, preferably 2 C and most preferably 3 C. A charging rate×C can be understood to mean the current intensity that is required in order to fully charge a discharged energy supply device in a fraction of one hour corresponding to the numerical value× of the charging rate×C. For example, a charging rate of 3 C allows the rechargeable battery to be fully charged within 20 minutes.

It is preferred in the context of the invention for the at least one cell of the energy supply device to have a surface A and a volume V, a ratio A/V of surface to volume being greater than six times, preferably eight times and particularly preferably ten times the reciprocal of the cube root of the volume.

The wording that the surface A of the at least one cell is greater than for example eight times the cube root of the square of the volume V can preferably also be expressed by the formula A>8*V\hat{ }(2/3). Written another way, this relationship can be described in that the ratio A/V of surface to volume is greater than eight times the inverse of the cube root of the volume.

To check whether the above relation is satisfied, values in the same basic unit must always be used. For example, if a value for the surface in m² is substituted into the above formula, a value for the volume in units of m³ is preferably substituted. For example, if a value for the surface in units of cm² is substituted into the above formula, a value for the volume in units of cm³ is preferably substituted. For example, if a value for the surface in units of mm² is substituted into the above formula, a value for the volume in units of mm³ is preferably substituted.

Cell geometries which, for example, satisfy the relationship A>8*V\hat{ }(2/3) advantageously have a particularly favorable ratio between the outer surface of the cell, which is critical for the cooling effect, and the cell volume. The inventors have recognized that the ratio of surface to volume of the at least one cell of the energy supply device has a major influence on the heat dissipation from the energy supply device. The improved cooling capability of the energy supply device can advantageously be achieved by increasing the cell surface given a constant volume and a low internal resistance of the at least one cell. It is preferred in the context of the invention for a low cell temperature given a simultaneously high power output to preferably be able to be rendered possible when the internal resistance of the cell is reduced. Reducing the internal resistance of the at least one cell can result in less heat being generated. In addition, a low cell temperature can be achieved by using cells in which the surface A of at least one cell within the energy supply device is greater than six times, preferably eight times and particularly preferably ten times the cube root of the square of the volume V of the at least one cell. As a result, in particular the heat dissipation to the environment can be improved.

It has been shown that energy supply devices whose cells satisfy the mentioned relationship can be cooled significantly better than previously known energy supply devices having, for example, cylindrical cells. The above relationship can be satisfied, for example, in that although the cells of the energy supply device have a cylindrical basic shape, additional surface-increasing elements are arranged on its surface. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cube-like basic shape. The term “substantially” is unclear to a person skilled in the art here because a person skilled in the art knows that, for example, a cuboid with indentations or rounded corners and/or edges should also be covered by the term “substantially cuboidal” in the context of the present invention.

It is preferred in the context of the invention for the at least one cell to have a cell core, no point within the cell core being more than 5 mm away from a surface of the energy supply device. When the energy supply device is discharged, for example when it is connected to a power tool and work is performed with the power tool, heat can be produced in the cell core. In this specific refinement of the invention, this heat can be transported on a comparatively short path up to the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the limit temperature being reached can advantageously be entirely avoided. As a further advantage of the invention, a relatively homogeneous temperature distribution can be achieved within the cell core. This can result in uniform aging of the rechargeable battery. This can in turn increase the service life of the energy supply device.

It is preferred in the context of the invention for the at least one cell to have a maximum constant current output of greater than 20 amperes, preferably greater than 30 amperes, most preferably greater than 40 amperes. The maximum constant current output is the quantity of current in a cell or an energy supply device that can be drawn without the cell or the energy supply device reaching an upper temperature limit. Possible upper temperature limits can lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 20 and 30 A, that is to say 21, 22.3, 24, 25.55 or 27.06 amperes etc., for example, should also be considered to be disclosed in the case of the maximum constant current output. Furthermore, values of between 30 and 40 A, that is to say 32, 33.3, 36, 38.55 or 39.07 amperes etc., for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating high-performance power tools in the construction industry. For example, the discharge currents can lie in a region of greater than 40 amperes, preferably greater than 60 amperes or even more preferably greater than 80 amperes.

It is preferred in the context of the invention for the cell to have a cell temperature gradient of less than 10 kelvin. The cell temperature gradient is preferably a measure of temperature differences within the at least one cell of the energy supply device, it being preferred in the context of the invention for the cell to have a temperature distribution that is as uniform as possible, that is to say for a temperature in an inner region of the cell to differ as little as possible from a temperature measured in the region of a lateral or outer surface of the cell.

The energy supply device has a nominal capacity of at least 1.5 ampere hours (Ah). Tests have shown that energy supply devices with a nominal capacity in excess of 1.5 Ah are particularly well suited to the use of high-performance power tools in the construction industry and meet the requirements there for the availability of electrical energy and the possible period of use of the power tool particularly well.

Here, the nominal capacity of the energy supply device is preferably measured at room temperature. The discharge current is preferably 10 A, wherein the discharging preferably ends at 2.5 V and charging preferably ends at 4.2 V. The cell is charged in accordance with the CCCV mode, wherein the abbreviation “CCCV” stands for constant current/constant voltage and is familiar to a person skilled in the art. The charging current here is preferably 0.5 C or 0.75 A, followed by a constant voltage phase up to 50 milliamperes (“constant voltage”). Plotting the discharge capacity in relation to the discharge current shows that nominal capacity values of more than 1.5 Ah are achieved. The nominal capacity values of more than 1.5 Ah are achieved in particular at discharge current values of greater than 15 amperes.

It has been found that the storage capacity or the capacity of the energy supply device or its cells with respect to electrical energy is dependent on the volume of the active material. The active material that cells can comprise is, for example, graphite or graphite-silicon as the anode material and at least one metal oxide as the cathode material. The at least one cathode material can preferably be Li, Ni, Mn, Co or Al oxides, or a mixture thereof. It has been found that typical specific capacities of the anode material are >180 mAh/g and of the cathode material are >350 mAh/g.

It is preferred in the context of the invention for no battery cells of the 14500 type to be used in energy supply devices for power tools. Rather, the battery cells used in the energy supply device are characterized in that the cells have a nominal capacity of at least 1.5 ampere hours, and also a surface A and a volume V, the surface A of the cells being greater than eight times the cube root of the square of the volume V of the cells. Alternatively or additionally, a ratio of resistance and surface of the cells can be less than 0.2 millionm/cm². Therefore, the invention specifically differs from 14500-type battery cells that are “customary in domestic applications”. It has been found that energy supply devices with said combination of features have particularly favorable heat emission properties. As a result, overheating of the energy supply device can be effectively prevented.

It is preferred in the context of the invention for the term “surface” to be understood to mean a maximum, enveloping lateral surface of an object. In the context of the present invention, this can mean, in particular, that the surface of a body or an object is interpreted as the sum of its boundary surfaces. In the context of the invention, the term “volume” is preferably understood to mean that cubic content which is enclosed by the maximum, enveloping lateral surface of the object.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures,

in which:

FIG. 1 shows a cross section through a system according to the invention comprising a power tool with a connected rechargeable battery as a power supply;

FIG. 2 shows a cross section through a base part of the power tool according to the invention with a connected rechargeable battery;

FIG. 3 shows a first graphical representation of the various voltage levels in a first and a second state for the differential communication in the system according to the invention;

FIG. 4 shows a second graphical representation of the various voltage levels in the first and second states for the differential communication in the system according to the invention;

FIG. 5 shows a third graphical representation of the various voltage levels in the first and second states for the differential communication in the system according to the invention;

FIG. 6 shows a graphical representation of the significance of signal interference for different-sized areas enclosed by the communication lines; and

FIG. 7 shows a further graphical representation of the significance of signal interference for different-sized areas enclosed by the communication lines.

FIG. 8 shows a schematic side view of a preferred embodiment of the energy supply device

FIG. 9 shows a schematic side view of a power tool with a preferred embodiment of the energy supply device

### DETAILED DESCRIPTION

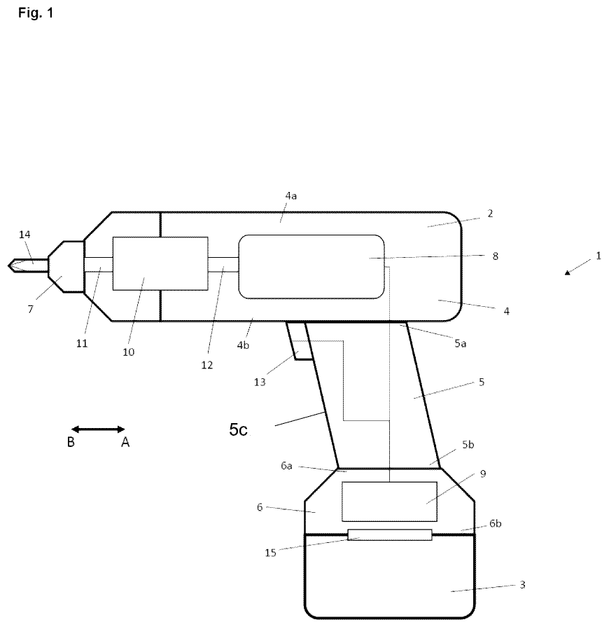

A preferred embodiment of the system 1 according to the invention with a power tool 2 and a rechargeable battery 3 is shown in FIG. 1. The rechargeable battery 3, which can also be referred to as an energy supply device, is connected to the power tool 2 and is used to supply the electrical loads of the power tool 2 with electrical energy. During the supply, electric current flows from the rechargeable battery 3 to the power tool 2. The rechargeable battery can also be referred to as a battery.

As illustrated in FIG. 1, the power tool 2 is shown in the form of a rechargeable-battery-operated screwdriver. According to other alternative embodiments, the power tool 2 can also be designed in the form of a power drill, a saw, a grinder or the like.

The power tool 2 designed as a rechargeable-battery-operated screwdriver substantially comprises a housing 4, a handle 5, a base part 6, a tool fitting 7, an electrical drive 8 in the form of an electric motor, a control device 9, a transmission 9a, a driveshaft 11, an output shaft 12 and an activation switch 13.

The electrical drive 8 designed as an electric motor, the transmission 10, the driveshaft 11, the output shaft 12 and the control device 9 are positioned in the housing 4. The drive 8, the transmission 10, the driveshaft 11 and the output shaft 12 are positioned in relation to one another and in the housing 10 such that a torque generated by the drive 8 is transmitted to the output shaft 12. The output shaft 12 transmits the torque to the transmission 10, which in turn passes on a torque to the driveshaft 11. The tool fitting 7 is driven by way of the driveshaft 11 by the transmission of the torque. As shown in FIG. 1, a tool 14 in the form of a bit is held in the tool fitting 7. The bit can be used to screw a screw into a material. Neither the screw nor the material is illustrated in the figures.

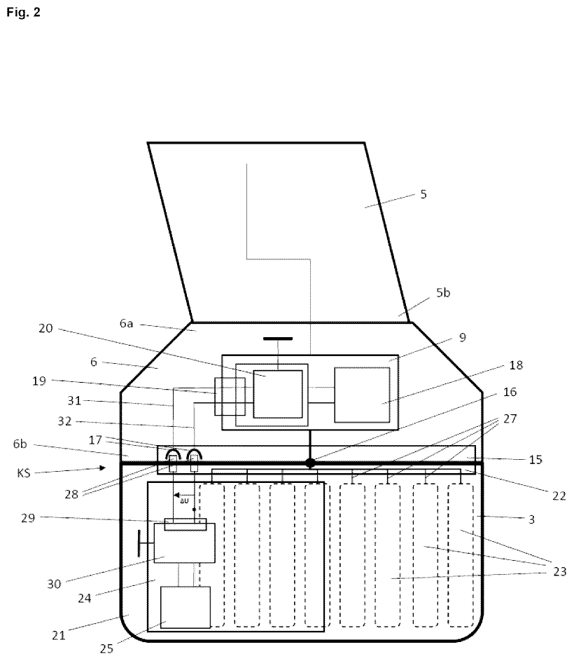

As also shown in FIG. 1, the housing 4 comprises an upper side 4a and an underside 4b. The handle 5 comprises a first end 5a and a second end 5b. The first end 5a of the handle 5 is secured to the underside 4b of the housing 4. Furthermore, the base part 6 comprises an upper end 6a and a lower end 6b. The upper end 6a of the base part 6 is secured to the second end 5b of the handle 5. The lower end 6b of the base part 6 comprises a mechanical, electrical and electronic interface 15 and is used for mechanical, electrical and electronic connection to the rechargeable battery 3. For the purpose of taking up electric current, the interface 15 comprises a number of power connections 16. The interface 15 additionally comprises data connections 17 (see, e.g., FIG. 2) for transmitting and receiving signals between the power tool 2 and the rechargeable battery 3.

As can be seen from FIGS. 1 and 2, the control device 9 of the power tool 2 is positioned in the base part 6 of the power tool 2. The control device 9 of the power tool 2 serves for the open-loop and closed-loop control of various processes in relation to the power tool 2 and in relation to the rechargeable battery 3. The control device 9 controls in particular the current or the intensity of the current that flows from the rechargeable battery 3 to the power tool 2, and in particular is used for driving the drive 8 formed as an electric motor.

The control device 9 of the power tool 2 contains a microcontroller 18 (also referred to as MCU) and a data interface 19 with a first transceiver 20 as part of a communication circuit KS for serial digital communication between the rechargeable battery 3 and the power tool 2. The data interface 19 of the power tool 2 is one of a total of two data interfaces to the communication circuit KS for the serial digital communication between the rechargeable battery 3 and the power tool 2. As also described below, the rechargeable battery 3 comprises the other of the two data interfaces 29.

The rechargeable battery 3 substantially comprises a housing 21 with a rechargeable battery interface 22. In the housing 21 of the rechargeable battery 3 there are a multiplicity of energy storage cells 23 and also control electronics 24 with a microcontroller 25.

The rechargeable battery 3 also contains a data interface 29 with a second transceiver 30 as part of a communication circuit KS for serial digital communication between the rechargeable battery 3 and the power tool 2.

The energy storage cells 23 may also be referred to as rechargeable battery cells and serve for taking up, storing and providing electrical energy or an electrical voltage.

The rechargeable battery interface 22 is positioned on one side of the housing 21. The rechargeable battery interface 22 comprises a number of power connectors 27 for taking up and delivering electric current and also data connectors 28 for transmitting and receiving signals between the power tool 2 and the rechargeable battery 3. The electric current from the energy storage cells 23 can be delivered by way of the power connectors 27.

As shown in FIGS. 1 and 2, the power connectors 27 of the rechargeable battery 3 are connected to the power connections 16 of the power tool 2. Similarly, the data connectors 28 of the rechargeable battery 3 are connected to the data connections 17 of the power tool 2.

Through the connection, electric current can flow from the energy storage cells 23 of the rechargeable battery 3 to the power tool 2. Furthermore, signals for communication between the energy supply device 3 and the power tool 2 can be exchanged. A wireless communication connection can preferably also exist between the transceivers 20, 30 of the system 1, which communication connection can include means for the wireless transmission of signals between the transceivers 20, 30, for example. It is preferred in the context of the invention for the means for wireless transmission of signals between the transceivers 20, 30 to also exchange signals and/or data using the serial digital communication.

As can be seen from FIG. 1, the activation switch 13 is positioned on a front side 5c of the handle 5. As a result of the activation switch 13 being moved in direction A, a signal can be transmitted from the activation switch 13 to the controller 9, as a result of which the controller 9 in turn transmits a signal to the control electronics 24 of the rechargeable battery 3. The signal transmitted to the control electronics 24 releases electrical energy or electric current with a specific current value from the rechargeable battery 3 for the electrical load of the power tool 2 and in particular the drive 8 formed as an electric motor. The power tool 2 has a current device (not shown) that can be used to measure the current intensity of the supply current. If a supply current with a permissible current intensity is measured, the supply current can flow to the electrical loads of the power tool 2. Alternatively or additionally, the current measuring device can also be positioned in the rechargeable battery 3. It is preferred in the context of the invention for the power tool 2 and the energy supply device 3 to comprise power lines 26 for conducting an electric current.

In order to transmit a signal corresponding to the travel of the activation switch 13 in direction A to the controller 9, the activation switch 13 comprises a potentiometer (not shown).

If the activation switch 13 moves again in direction B, a corresponding signal is transmitted to the controller 9 by means of the potentiometer (not shown), with the result that electric current (and consequently electrical energy) no longer flows from the rechargeable battery 3 to the power tool 2.

The serial digital communication between the rechargeable battery 3 and the power tool 2 takes place via a communication connection that can comprise a communication circuit KS having at least one first communication line 31. Alternatively or additionally, the communication connection can be wireless and comprise means for wireless signal transmission using the serial digital communication. To participate in the communication circuit KS, both the rechargeable battery 3 and the power tool 2 respectively comprise a data interface 19, 29 with a transceiver 20, 30. The transceivers 20, 30 can in this case be designed as CAN transceivers. As indicated in FIG. 2, the transceiver 20 of the power tool is connected to the transceiver 30 of the rechargeable battery 3 by way of the data interface and a first communication line 31 (also referred to as the COM high line) and a second communication line 32 (also referred to as the COM low line) and the data interface 29.

According to an alternative embodiment of the present invention that is not shown in the figures, the communication circuit KS having a first transceiver 20 and a second transceiver 30 can merely be positioned in the housing 4 of the power tool 2. As a result, the differential communication merely takes place within the power tool, i.e. between components of the power tool 2

The transceiver 20 of the power tool 2 can transmit signals (for example a bit) by way of the data interface 19 and the first and second communication lines 31, 32 to the data interface 29 and the transceiver 30 of the rechargeable battery 3.

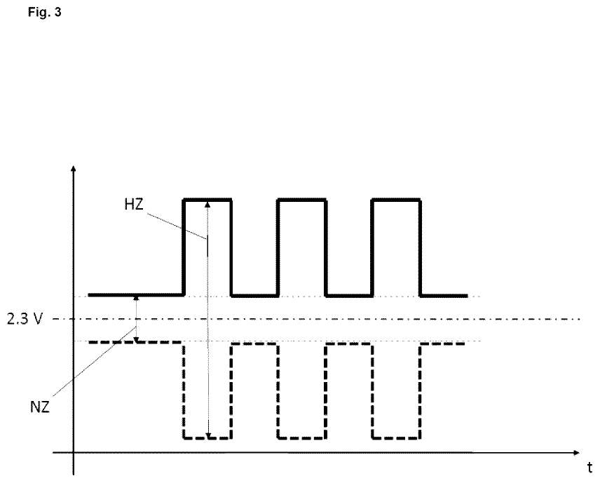

As shown in FIGS. 3 to 5, to transmit a signal in the form of a bit by way of the communication circuit KS, both the COM high line 31 and the COM low line 32 (see, e.g., FIG. 2) are set to a first state HZ. The first state HZ for the COM high line 31 and the COM low line 32 is the high state, i.e. at which there is a first differential voltage of between 1.5 and 3 V. In the exemplary embodiment in FIG. 3, the first differential voltage for the first (high) state HZ is in this case 3 V.

The exemplary embodiments of the invention that are shown in FIGS. 3 to 5 relate in particular to differential communication using two communication lines 31, 32 between the transceivers 20, 30, which are intended to exchange data and/or signals with one another.

The second state NZ for the COM high line 31 and for the COM low line 32 is the low state, i.e. at which there is a second differential voltage of between −0.5 and 0.5 V. An optimum value for the second differential voltage is in this case 0 V. In the exemplary embodiment in FIG. 3, the second differential voltage for the second (low) state NZ is 0.5 V.

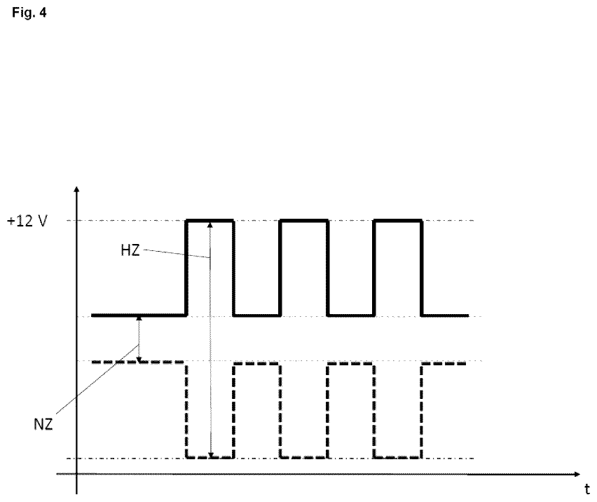

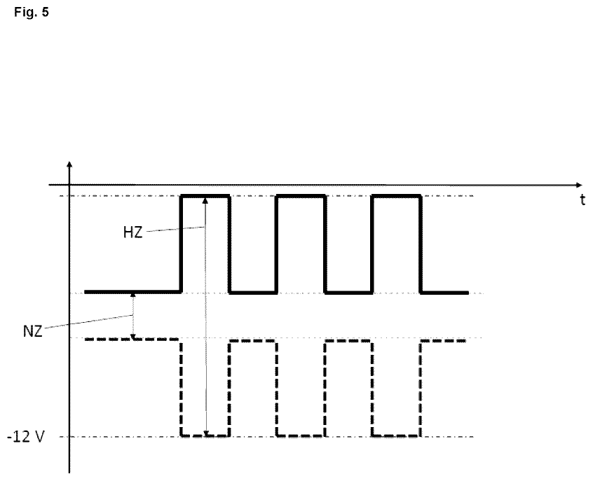

As shown accordingly in FIGS. 4 and 5, the maximum voltage value in the first state can be up to 12 V (i.e. −12 V or +12 V) with respect to the ground potential of the rechargeable battery 3.

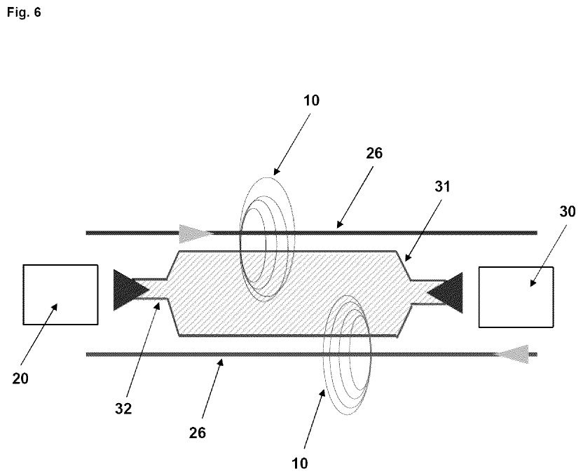

FIG. 6 shows a graphical representation of the significance of signal interference 10 for different-sized areas enclosed by the communication lines 31, 32. The communication lines 31, 32 run between the first transceiver 20 and the second transceiver 30, the first transceiver 20 preferably being able to be part of the power tool 2, while the second transceiver 30 is arranged on the energy supply device 3. In addition, FIG. 6 shows power lines 26 through which electric current I can flow. In the communication system shown in FIG. 6, the communication lines 31, 32 enclose a large area with each other, with the result that signal interference 10 has a significant impact on the communication between the first transceiver 20 and the second transceiver 30. This signal interference 10 affects the communication lines 31, 32 in particular as a result of strong inductive coupling.

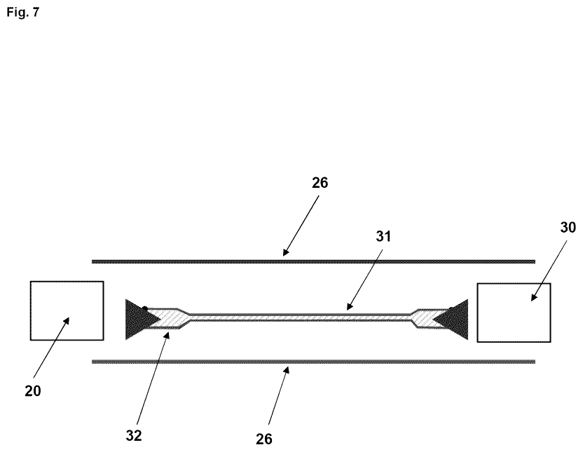

FIG. 7 shows a graphical representation of a more preferred embodiment of the power tool 2, in which there is a smaller interval between the communication lines 31, 32 or in which a smaller area is enclosed by the communication lines 31, 32. As can be seen from FIG. 7 in comparison with FIG. 6, such an embodiment of the communication circuit KS sees the influence of signal interference 10 on the serial digital communication significantly reduced, and data and/or signals can be exchanged between the communication partners, such as the power tool 2 and the rechargeable battery 3, in a particularly interference-free and robust manner. It is very particularly preferred in the context of the invention for an area that can be enclosed by the communication lines 31, 32 to be less than 20 cm² if more than one communication line is used for the serial digital communication.

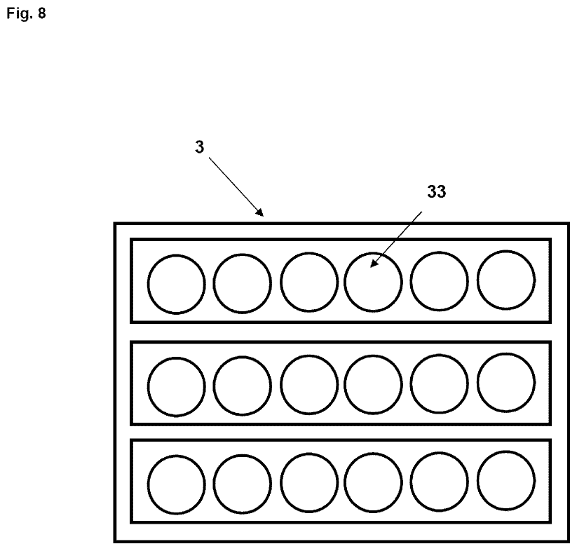

FIG. 8 shows a schematic side view of a preferred embodiment of the energy supply device 3. The energy supply device 3 shown in FIG. 8 has eighteen cells 33, the eighteen cells 33 being arranged in three strings within the energy supply device 3. In particular, the cells 33 are symbolized by the circles, while the strings are symbolized by the elongate rectangles surrounding the circles (“cells 33”).

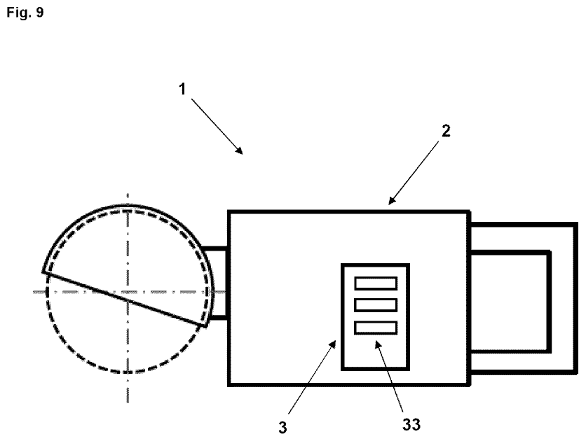

FIG. 9 shows a schematic view of a power tool 2 with a energy supply device 3. The power tool 2 can be a cut-off grinder, for example, which has a cutting disk as a tool. The power tool 2 can have a grip which is designed, for example, as a rear handle. In addition, the power tool 2 can have control elements, such as switches or buttons, in a manner known per se. Moreover, the power tool 2 can have a motor (not shown), which can represent a load and can be supplied with electrical energy by the energy supply device 3. In the schematic exemplary embodiment of the system 1 comprising the power tool 2 and the energy supply device 3, the energy supply device 3 has three energy storage cells 33.

### LIST OF REFERENCE SIGNS

1 System
2 Power tool
3 Rechargeable battery
4 Housing
Handle
5a First end of the handle
5b Second end of the handle
5c Front of the handle
6 Base part
6a Upper end of the base part
6b Lower end of the base part
7 Tool fitting
8 Electric drive, e.g. electric motor
9 Control device
9a Transmission
Signal interference
11 Driveshaft
12 Output shaft
13 Activation switch
14 Tool
Interface
16 Power connections
17 Data connections
18 Microcontroller
19 First data interface, for example on the power tool
First transceiver
21 Housing
22 Rechargeable-battery interface
23 Energy storage cells
24 Control electronics
Microcontroller
26 Power line
27 Power connector
28 Data connector
29 Second data interface, for example on the energy supply device
Second transceiver
31 First communication line, “COM high line”
32 Second communication line, “COM low line”
33 Energy storage cell of the energy supply device
KS Communication circuit
HZ First state
NZ Second state

1-15. (canceled)

16. A power tool comprising:
at least one control device, the power tool detachably connectable to an energy supply device, and
at least one communication connection for the exchange of signals between a first transceiver and a second transceiver by using serial digital communication, wherein the energy supply device includes at least one energy storage cell having a nominal capacity of at least 1.5 ampere hours, and also a surface A and a volume V, the surface A being greater than eight times the cube root of the square of the volume V.

17. The power tool as recited in claim 16 wherein the signals are exchanged in a half-duplex mode or in a full-duplex mode.

18. The power tool as recited in claim 16 wherein the signals are exchanged with reference to ground.

19. The power tool as recited in claim 16 wherein the signals are exchanged as part of differential communication.

20. The power tool as recited in claim 19 wherein a first differential voltage in the differential communication for a first state is between −20 V and 1 volt and a second differential voltage for a second state is between 1.5 and 20 volts.

21. The power tool as recited in claim 16 wherein the communication connection comprises a communication circuit having at least one communication line for wired transmission of signals by way of the serial digital communication or a wireless connection for wireless transmission of signals by way of the serial digital communication.

22. The power tool as recited in claim 16 wherein the first transceiver is positioned in the power tool and the second transceiver is positioned in the energy supply device.

23. The power tool as recited in claim 16 wherein a data transmission rate is in a range from 9.6 kbit/s to 5 Mbit/s.

24. The power tool as recited in claim 21 wherein a resistance of the at least one communication line is less than 1 ohm.

25. The power tool as recited in claim 21 wherein the communication lines are twisted if more than one communication line is used for the serial digital communication.

26. The power tool as recited in claim 21 wherein intervals between line crossing points between the communication lines are in a range from 5 mm to 25 mm if more than one communication line is used for the serial digital communication.

27. The power tool as recited in claim 21 wherein an area enclosed by the communication lines is less than 20 cm² if more than one communication line is used for the serial digital communication.

28. The power tool as recited in claim 21 wherein the serial digital communication is based on near-field communication.

29. The power tool as recited in claim 16 wherein an antenna area of the first transceiver or of the second transceiver is in a range from 4 cm² to 20 cm² or an interval between antennas of the first transceiver and the antennas of the second transceiver is less than 4 cm.

30. A system comprising the power tool as recited in claim 16 and the energy supply device.
